(19) United States
(12) Patent Application Publication
(10) Pub. No.: US 2003/0203994 A1
(43) Pub. Date: Oct. 30, 2003

(54) Solventless photo-sensitive thermosetting-type ink

(76) Inventors: Michael Chen, Chung-Li City (TW); Todd Yeh, Taoyuan City (TW)

Correspondence Address: BIRCH STEWART KOLASCH & BIRCH, PO BOX 747, FALLS CHURCH, VA, 22040-0747, US

(21) Appl. No.: 10/132,183

(22) Filed: Apr. 26, 2002

(51) Int. Cl. C08L 63/00

(52) U.S. Cl. 523/466

(57) ABSTRACT

The present invention relates to a solventless photo-sensitive thermosetting type of material, a method for manufacturing the same, and its use; wherein said solventless photo-sensitive thermosetting type of material mainly comprises an aqueous alkaline-developable photo-sensitive resin, unsaturated monomer(s), epoxy resin(s), photo initiator(s), and is manufactured through a ring-opening condensation reaction as an initiation step, which is characterized in that a photo-sensitive monomer containing an unsaturated bond is used to replace organic solvent(s) regularly used in conventional solder mask products.

### FIELD OF THE INVENTION

The present invention provides a solventless photo-sensitive thermosetting-type material, and a method for using such a solventless photo-sensitive thermosetting-type material. Such a material is used in a procedure of electroplating a holed copper in a process for producing a printed circuit board (PCB).

### BACKGROUND OF THE INVENTION

Recently, due to the miniaturization of electronic products, the development of the PCBs is also towards lighter, thinner, shorter, and smaller products. Therefore, multi-layered PCBs using build-up process are becoming more common in the PCB industry. Usually, the circuits of different layers on a multi-layered PCB must be inter-connected by making through holes and plating copper on the wall of through, i.e. a so-called plated through hole (PTH) procedure. If the conductive copper within the through hole is not protected and exposed to atmosphere, the copper can be oxidized, causing a breakage in conduction among circuits, rendering circuit board unreliable. Therefore, there is a need to further fill these through-holes with polymer material(s) in order to protect the thin conductive copper layer within the through-hole. FIG. 1 shows the schematic diagram of a through-hole structure formed in a conventional PCB, wherein the through-hole structure comprises: a substrate 1, a through-hole 2 formed by a through hole on said substrate 1, a copper ring 21 formed on the wall of through-hole of said substrate 1.

Commonly (not build-up process), solvent-containing solder mask can be used to fill the through hole for the protective purpose. Using solder mask for via filling, though inexpensive and easy to apply, involves a major drawback, that is, the large volume shrinkage the filling material has to endure, caused by loss of solvent upon baking. To compensate for this volume shrinkage (generally 30-40%), the surface of via filling material must indent deeply, which might be all right for many applications, but is not acceptable for the build-up process. A schematic diagram of the above mentioned problem of severe indentation at the filling surfaces is shown in FIG. 2. Also commonly seen with the usage of solder mask 3 for filling the through-hole is the phenomenon of flat filling surface but foamed-up interior 31. Though seemingly acceptable, this is probably less reliable than it looks. The purpose of protecting plated-through-hole copper by the filling material, in this case, may not have been accomplished, because physical integrity of the filling material itself is in doubt. Therefore the practice of using commercial solder mask products for filling through-holes leaves much room for improvement. It has not been an option in the build-up process.

In the case of build-up process, people in the industry generally rely on some solventless (some of these products do contain minor amount of solvent, but can be viewed as essentially solventless) thermosetting type of via filling material for via filling. Although this type of product is far more effective for filling than regular solder mask (it does not have to endure the same kind of volume shrinkage caused by the loss of solvent), it is not without problems. One problem that people encounter quite often is air bubbling. Owing to its relatively high viscosity, air bubbles existing in the liquid are difficult to remove. These bubbles will expand upon heating during the baking process, thus affecting the physical integrity of the filling. Moreover, this process requires delicate afterwards polishing so that surface of the filling material is flat for the next build-up layer. This, of course, increases complexity and cost of the process.

Furthermore, all the existing commercial solder mask products contain some organic solvents to maintain it at liquid state so that it can be applied to the surface of substrate by various coating methods. Afterwards, a pre-baking process is used to remove these organic solvents so that the ensuing UV exposure step can be carried out on the non-tacky coating surface. It is obvious that the sole purpose of organic solvents is only to satisfy the need of the coating process. The practice of adding organic solvents, however, creates problems in areas of health, safety and environmental protection. With latest advance in UV exposure technology, namely the introduction of non-contact laser UV exposure equipment, the exposure step can be carried out onto a liquid coating surface. With this advance, the process of applying solder mask can be improved by removing organic solvents from the system, i.e. by developing a solventless solder mask product.

The advantages of using a solventless solder mask system are several. First and foremost, of course, is the improvement in environment, safety and health. From the standpoint of reducing processing headaches, there is one less worry about entrapped air bubble since there is no organic solvent, resulting in better integrity of the filling. The application of this product is schematically shown in FIG. 4. After thermosetting of the plug ink 3, the surfaces on the two ends of the cylinder formed by this product and the copper ring 21 are planar 41. This product is also photo-sensitive with reduced viscosity (relative to most commercial via-filling materials). These characteristics help resolve the long nagging issues for many process engineers as to achieve a solid filling without voids or cracks. The processing of this product is similar to that of solder mask but without the need for pre-baking. After having been coated onto the substrate, it is subject to UV exposure for hardening. Surface flatness can be accomplished by pressing a flat plastic film against the liquid coating during UV exposure, and later remove the plastic film, washing off the unwanted part in the developing step. Another option of flattening the surface is to polish the protruded part after UV exposure. Since the material is only semi-hardened at this stage, polishing can be carried out in a relatively easy manner. The semi-hardened material can then go through the thermosetting step to fully harden it. The introduction of the photo-setting step, although seemingly redundant, serves to ensure the integrity of the filling, so that it can be without voids, cracks or indentations. In addition, it takes care of the concern that the filling material 3 may flow out of the hole 51 due to reduced viscosity upon heating as shown in FIG. 3.

A major different between the present invention and existing commercial via filling materials is the photo-sensitivity. With this, the task of via filling is simplified and the quality improved. It can, of course, also be used as regular solder mask.

### SUMMARY OF THE INVENTION

The main objective of the present invention is to provide a method for producing a solventless photo-sensitive thermosetting type of material. This material produced according to the present invention can improve over problems caused by conventional via-filling materials in the build-up process. This material according to the present invention comprises:

one or more aqueous alkali developer-type photosensitive resins;

one or more unsaturated acids;

one or more poly-anhydrides;

one or more photo-sensitive monomers containing unsaturated bonds;

one or more epoxy resin thermal curing agents;

one or more photo initiators;

optionally, one or more inorganic fillers, defoaming agents, Theological agents and other diluents.

A method for producing a solventless photo-sensitive thermosetting type of material comprises synthesizing a photosensitive binder, mixing and milling of this binder with other ingredients for the final product.

Synthesizing Step:

Epoxy resin(s) such as phenol novolac, cresol novolac type epoxy resin(s) are mixed with an unsaturated carboxylic acid such as acrylic acid or methacrylic acid to create binders with unsaturated groups. Suitable amount of catalyst such as triphenyl phosphine should also be added to accelerate the reaction. Unsaturated monomer(s) such as trimethylolpropane tiracrylate are also added to adjust the viscosity, and also to enhance the photo-sensitivity of the system. The reaction is generally carried out at 80-110° C. for 24-96 hours. When the acid number of the reaction mixture drops to below 2 mg KOH/g, then it can proceed to the next stage of reaction step; For the next stage of reaction step, add poly-anhydride(s) to the reaction mixture from the synthesizing step. Also add suitable amount of unsaturated monomer(s) to adjust viscosity. The reaction is then carried out at 80-110° C. for 6-24 hours, wherein the acid number of the final photo-sensitive resin is preferably 60-140 mg KOH/g;

Mixing and Milling Step:

Mix the photo-sensitive resin obtained from the previous with suitable photo initiator(s), curing agent(s), inorganic filler(s), pigment(s), de-foamer(s), and other rheological agent.

A secondary objective of the present invention is to provide a solventless photo-sensitive thermosetting type of material. Such a product can also be used as solder mask. Thus, the processes of solder masking and via filling can be combined into one. The pre-baking process can be altogether eliminated by using a projective UV exposure.

### BRIEF DESCRIPTION OF THE DRAWINGS

FIG. 1 shows a schematic diagram of a via structure of a conventional PCB;

FIG. 2 shows the indentation caused by volume shrinkage;

FIG. 3 shows the dripping of filling material around via edges;

FIG. 4 shows a good via-filling according to the present invention; and

FIG. 5 is the flowchart of a process for producing a solventless photo-sensitive thermosetting type of material.

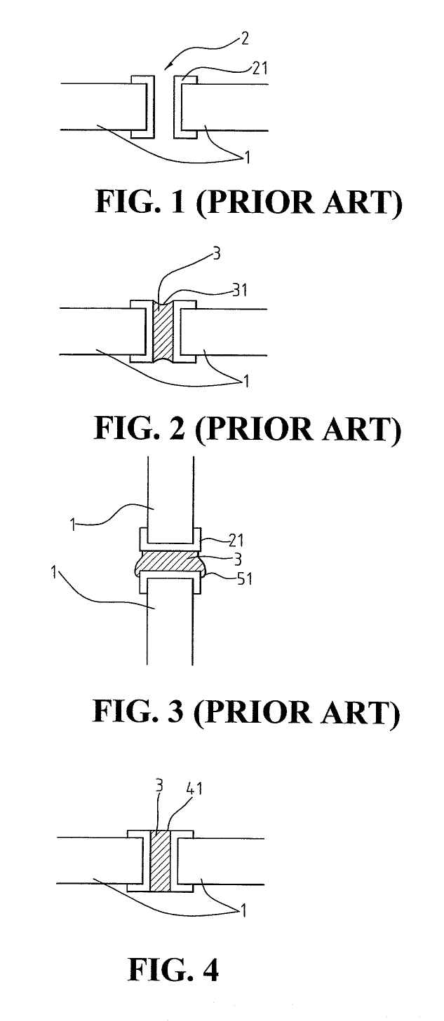

### DESCRIPTION OF THE EMBODIMENTS OF THE INVENTION

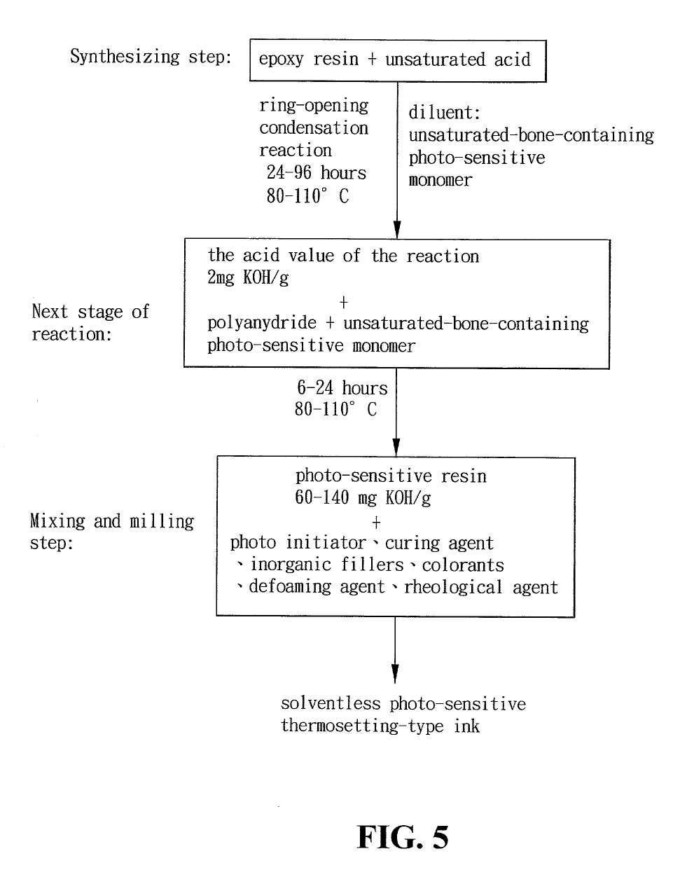

As shown in FIG. 5, a method for producing a solventless photo-sensitive thermosetting type of material according to the present invention comprises the following steps:

Synthesizing Step:

Using an epoxy resin as a base to perform a ring-opening condensation reaction with an unsaturated acid, adjusting the viscosity of the mixture by adding suitable monomer(s), wherein the reaction time is 24-96 hours, and the reaction temperature is 80-110° C.; when the acid number of the reaction mixture drops to below 2 mg KOH/g, it can then proceeds to the next stage of reaction step;

Next Stage of Reaction Step:

Allowing the reaction mixture from the synthesizing step, a poly-anhydride, and suitable monomer(s) to react at 80-110° C. for 6-24 hours, wherein the acid number of the final photo-sensitive resin is preferably 60-140 mg KOH/g;

Mixing and Milling Step:

Adding the photo-sensitive resin obtained from the intermediate step with suitable amount of a photo initiator(s), curing agent(s), inorganic filler(s), pigment(s), de-foamer(s), and a rheological agent.

A solventless photo-sensitive thermosetting type of material according to the present invention mainly comprises:

one or more epoxy resin thermal curing agents, which include:

Bisphenol-A epoxy resin, Bisphenol-F epoxy resin, Phenol novolac epoxy resin, Cresol novolac epoxy resin, or insoluble or slightly soluble powder epoxy resins and other hetero-ring type epoxy resins, wherein the amount of the epoxy resin is determined according to the actual need and can be based on 100 parts for calculating the ratio of other components;

one or more unsaturated acids, which include:

acrylic acid, methacrylic acid, crotonic acid and other double-bond unsaturated acids;

one or more polyanhydrides, which include:

tetrahydrophthalic anhydride, maleic anhydride, succinic anhydride, phthalic anhydride and other polyanhydrides;

one or more unsaturated photo-sensitive monomers, which include:

polyethylene glycol diacrylate, diacrylate, trimethylopropane triacrylate, triethylene glycol diacrylate, tripropylene glycol diacrylate and other unsaturated photo-sensitive monomers;

one or more photo initiators, which include:

2-methyl-1-(└4-(methylthio)phenyl┐-2-morpholinopropanone), 2-isopropylthioxanthone and other photo initiators;

Optionally, one or more inorganic fillers, which include: silicon dioxide, barium sulfate, quartz powder, mica powder, etc. for adjusting the physical properties, such as dielectric properties, acid resistance, and Theological properties, etc., of the ink;

optionally, one or more organic agents for assisting the physical properties of the ink which include: defoaming agents, rheological agents, and other diluents, etc.

The synthesis and formula of an example of the present invention is described in detail in the following:

### EXAMPLE 1:

TABLE 2
Compounding of solventless photo-sensitive thermal-setting materials

| | Exp. 5 | Exp. 6 | Exp. 7 | Exp. 8 | Exp. 9 | Exp. 10 |
|---|---|---|---|---|---|---|
| Exp. 1 binder | 182 | 182 | 182 | 0 | 0 | 0 |
| Exp. 2 binder | 0 | 0 | 0 | 125 | 0 | 0 |
| Exp. 3 binder | 0 | 0 | 0 | 0 | 167 | 0 |
| Exp. 4 binder | 0 | 0 | 0 | 0 | 0 | 125 |
| Dow DER 383 | 45 | 0 | 30 | 45 | 45 | 45 |
| LG N830 | 0 | 45 | 0 | 0 | 0 | 0 |
| TEPIC | 0 | 0 | 15 | 0 | 0 | 0 |
| Melamine | 5 | 5 | 5 | 5 | 5 | 5 |
| Aerosil 300 | 3 | 3 | 3 | 3 | 3 | 3 |
| Irgacure 907 | 15 | 15 | 15 | 15 | 15 | 15 |
| ITX | 2 | 2 | 2 | 2 | 2 | 2 |
| Defoamer | 3 | 3 | 3 | 3 | 3 | 3 |
| KS-66 | | | | | | |
| Developability¹ | Pass | Pass | Pass | Pass | Pass | Pass |
| Photo- | 9 | 9 | 10 | 7 | 8 | 6 |
| sensitivity² | | | | | | |
| Solder resist³ | Pass | Pass | Pass | Pass | Pass | Pass |
| Adhesion⁴ | Pass | Pass | Pass | Pass | Pass | Pass |

¹Developed by 1% Na₂CO₃ @ 30° C., 2 kg/cm², 60 seconds
²Stouffer 21-step photo guide @ 30 mJ/cm², 7 kW UV exposure
³250° C. solder bath, 15 seconds x 3
⁴100-square cross-cutter test, per IPC TM-650 2.4.1.1B

The synthesis and formula described in Example 1 is used to describe the feasibility of the solventless photo-sensitive thermosetting-type inks according to the present invention.

Thus, a solventless photo-sensitive thermosetting-type ink according to the present invention can achieve the desired objectives and effects through the disclosure in the present invention, and meets the novelty, improvement and industrial utility requirements of a patent.

The above-mentioned example is a preferred example only, and is not used to limit the scope of the present invention. Any alteration or modification to the present invention within the creation spirit of the present invention is still within the scope of the present invention.

What is claimed is:

1. A method for producing a solventless photo-sensitive thermosetting-type ink, which comprises the following steps:
synthesizing step:
Using an epoxy resin as a base to perform a ring-opening condensation reaction with an unsaturated acid, adding suitable unsaturated monomer(s) into the mixture for dilution; wherein said epoxy resin at least includes: Bisphenol-A epoxy resin, Bisphenol-F epoxy resin, Phenol novolac epoxy resin, Cresol novolac epoxy resin;
Allowing the reaction mixture from the synthesizing step, poly-anhydride(s), and suitable monomer(s) to perform reactions;
mixing and milling step:
Adding the photo-sensitive resin obtained from the intermediate step with suitable photo initiator(s), curing agent(s), inorganic filler(s), pigment(s), de-foamer, and rheological agent(s).

2. The method according to claim 1, wherein said monomer at least includes: polyethylene glycol diacrylate, diacrylate, trimethylopropane triacrylate, triethylene glycol diacrylate, tripropylene glycol diacrylate and other unsaturated photo-sensitive monomers.

3. The method according to claim 1, wherein said epoxy resin thermal curing agent at least includes: Bisphenol-A epoxy resin, Bisphenol-F epoxy resin, Phenol novolac epoxy resin, Cresol novolac epoxy resin, or insoluble or slightly soluble powder epoxy resins and other hetero-ring type epoxy resins, wherein the amount of the epoxy resin is determined according to the actual need and can be based on 100 parts for calculating the ratio of other components.

4. The method according to claim 1, wherein said unsaturated acid at least includes: acrylic acid, methacrylic acid, crotonic acid and other double-bond unsaturated acids.

5. The method according to claim 1, wherein said polyanhydride at least includes: tetrahydrophthalic anhydride, maleic anhydride, succinic anhydride, phthalic anhydride and other polyanhydride.

6. The method according to claim 1, wherein the photo initiator at least includes: 2-methyl-1-(└4-(methylthio)phenyl┐-2-morpholinopropanone), 2-isopropylthioxanthone and other photo initiators.

7. The method according to claim 1, wherein said inorganic filler is optionally added with silicon dioxide, barium sulfate, quartz powder, mica powder, etc. for adjusting the physical properties, such as dielectric properties, acid resistance, and rheological properties, etc., of the ink.

8. The method according to claim 1, wherein said organic agents for assisting the processing properties required by via filling are optionally added and include: de-foamer(s), Theological agent(s), and other diluents, etc.

9. The method according to claim 1, wherein said initiation step takes 24-96 hrs at 80-110° C., and said intermediate step takes 6-24 hrs at 80-110° C.

10. A method of using a solventless photo-sensitive thermosetting type of material, which comprises using said material as solder mask, and using a projection-type UV exposure and an aqueous alkali developing step to eliminate the pre-baking process, so as to simplify the production process and improve the yield.
